(19) United States
(12) Patent Application Publication
(10) Pub. No.: US 2015/0199441 A1
(43) Pub. Date: Jul. 16, 2015

(54) METHOD AND APPARATUS FOR PROVIDING TOUR PLAN SERVICE

(71) Applicant: DABEEO, INC., Seoul (KR)

(72) Inventor: Ju Hum PARK, Seoul (KR)

(21) Appl. No.: 14/336,043

(22) Filed: Jul. 21, 2014

(30) Foreign Application Priority Data
Jan. 10, 2014 (KR) 10-2014-0003510

(51) Int. Cl. G06F 17/30; G06Q 50/00; G06Q 50/14

(52) U.S. Cl. CPC G06F 17/30867; G06F 17/30873; G06Q 50/14; G06Q 50/01

(57) ABSTRACT

An exemplary embodiment of the present invention provides a method for providing a tour plan service by a tour service providing apparatus. The tour service providing apparatus determines a tendency of a first user based on Internet using information of the first user. The tour service providing apparatus searches at least one first place content corresponding to the tendency of the first user. And the tour service providing apparatus provides a first tour plan created by using the first place content, to the first user.

### CROSS-REFERENCE TO RELATED APPLICATION

This application claims priority to and the benefit of Korean Patent Application No. 10-2014-0003510 filed in the Korean Intellectual Property Office on Jan. 10, 2014, the entire contents of which are incorporated herein by reference.

### BACKGROUND OF THE INVENTION

(a) Field of the Invention

The present invention relates to a method and an apparatus for automatically providing a tour plan service.

(b) Description of the Related Art

In accordance with a conventional tour plan service, as tour tendencies of a user is directly set by the user, tour courses corresponding to the set tour tendencies are suggested to the user. This kind of conventional tour plan service completely depends on inputs of the user to recognize tendencies of the user. As a result, according to the conventional tour plan service, there is a troublesome that users directly manually set their tour tendencies and a problem in that it is difficult to determine how much degree the set tendencies correspond to real tendencies of the users.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for automatically providing an optimized tour plan to a user by automatically recognizing (analyzing) tendencies of the users.

An exemplary embodiment of the present invention provides a method for providing a tour plan service by a tour service providing apparatus. The method for providing a tour plan service includes: determining a tendency of a first user based on Internet using information of the first user; searching at least one first place content corresponding to the tendency of the first user; and providing a first tour plan created by using the first place content, to the first user.

The demining of the tendency of the first user may include creating a first database for storing tendency information of the first user based on the Internet using information of the first user, and the Internet using information of the first user may include at least one of information related to use of the tour plan service by the first user, information related to use of a service different from the tour plan service by the first user, and information related to use of a social network service (SNS) by the first user.

The first place content may include at least one attribute, and the searching may include searching the first place content having an attribute corresponding to the tendency of the first user by using a second database for storing at least one place content.

The attribute of the first place content may be adjusted based on a tendency of a user who uses the first place content.

The first place content may include: a primary attribute having a predetermined value; and a secondary attribute that is adjusted based on the tendency of the user who uses the first place content.

The providing may include: receiving a selection rule from the first user; and creating the first tour plan based on the selection rule.

The selection rule may be at least one of a tour schedule, a travel destination, a place content attribute, and a travel expense.

The creating of the first tour plan may include, when no selection rule is inputted, determining at least one travel destination, a tour schedule, and a sub tour place in the travel destination, which are preferred by users having the same tendencies as the first user in a current season by using the first place content; creating a first tour plan including the determined travel destination, tour schedule, and sub tour place; and selecting a second tour plan having a number of times at which they are suggested that is equal to or greater than a threshold value among tour plans including the first place content.

The creating of the first tour plan may include, when the travel destination is inputted as the selection rule, searching at least one second place content corresponding to the inputted travel destination among the first place contents; determining a tour schedule and at least one sub tour place in the travel destination by using the second place content, and creating a first tour plan including the determined tour schedule and sub tour place; and selecting a second tour plan that is used by users having the same tendencies as the first user among tour plans including the second place content.

The creating of the first tour plan may include, when the place content attribute is inputted as the selection rule, searching at least one second place content corresponding to the inputted attribute among the first place contents; determining a tour schedule and at least one travel destination by using the second place content, and creating a first tour plan including the determined tour schedule and travel destination; and selecting a second tour plan that is used by users having the same tendencies as the first user among tour plans including the second place content.

The creating of the first tour plan may include, when the travel expense is inputted as the selection rule, searching at least one second place content corresponding to the inputted travel expense among the first place contents; determining a tour schedule, at least one travel destination, and at least one sub tour place in the travel destination by using the second place content, and creating a first tour plan including the determined tour schedule, travel destination and sub tour place; and searching tour plans that are used by users having the same tendencies as the first user among tour plans including the second content, and selecting a second tour plan corresponding to the inputted travel expense among the searched tour plans.

The creating of the first tour plan may include, when the tour schedule is inputted as the selection rule, searching at least one second place content corresponding to the inputted tour schedule among the first place contents; determining at least one travel destination by using the second place content, and creating a first tour plan including the determined travel destination; and selecting a second tour plan that is used by users having the same tendencies as the first user among tour plans including the second place content.

Another embodiment of the present invention provides a tour service providing apparatus for providing a tour plan service. The tour service providing apparatus includes: a first database configured to store user tendency information of at least one user; a second database configured to store at least one place content; and a processor configured to create a tour plan by matching the tendency information of the users to the place contents. The processor stores, in the first database, tendency information of a first user among the users, analyzed based on Internet using information of the first user, searches at least one first place content corresponding to the tendency information of the first user among the place contents by using the second database, and provides a first tour plan created by using the first place content, to the first user.

### BRIEF DESCRIPTION OF THE DRAWINGS

FIG. 1 shows a tour service providing apparatus in accordance with an exemplary embodiment of the present invention.

FIG. 2 conceptually shows attributes of place contents in accordance with the exemplary embodiment of the present invention.

FIG. 3A and FIG. 3B show information that is collected to recognize user tendencies in accordance with the exemplary embodiment of the present invention.

FIG. 4 shows one example of user tendency information in accordance with the exemplary embodiment of the present invention.

FIG. 5 shows another example of user tendency information in accordance with the exemplary embodiment of the present invention.

FIG. 6 is a graph showing a relationship between user tendencies and place contents in accordance with the exemplary embodiment of the present invention.

FIG. 7 is a flowchart showing how the tour service providing apparatus provides a tour plan service in accordance with the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

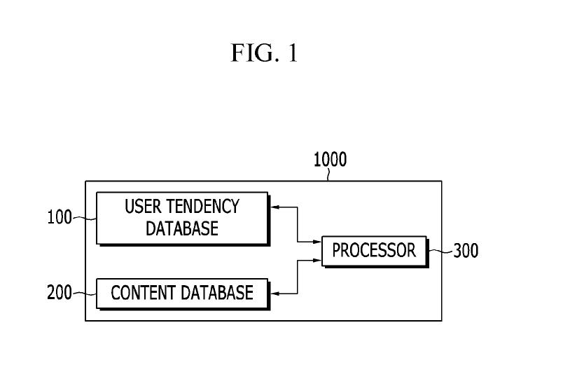

FIG. 1 shows a tour service providing apparatus in accordance with an exemplary embodiment of the present invention. The tour service providing apparatus 1000 automatically analyzes ever-changing tendencies of a user and provides optimized tour contents (e.g., tour plans such as tour courses) corresponding to the analyzed tendencies. Herein, the tour service providing apparatus 1000 may be a server.

The tour service providing apparatus 1000 includes a user tendency database 100, a content database 200, and a processor 300.

The content database 200 includes at least one place content. Each place content has at least one attribute

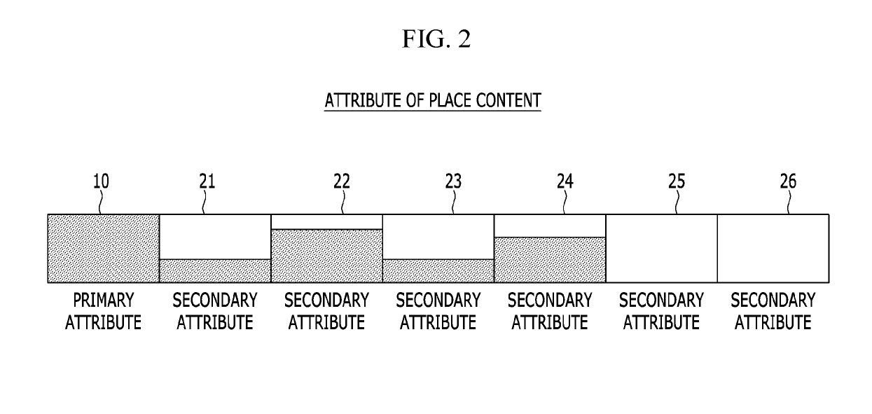

Herein, the attribute indicates features, such as tourism, shopping, culture, history, nature, experience, favorite restaurant information, and the like, which can be included in a corresponding place. For example, when a specific place (e.g., Myeong-dong) is famous for shopping and as a historic place, a corresponding content may have a shopping attribute and a history attribute. The content database 200 will be described in detail with reference to FIG. 2.

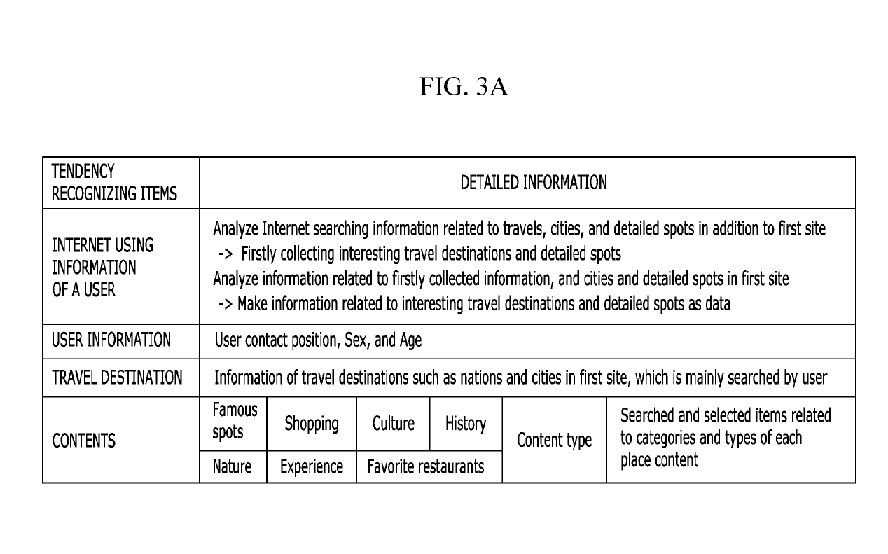

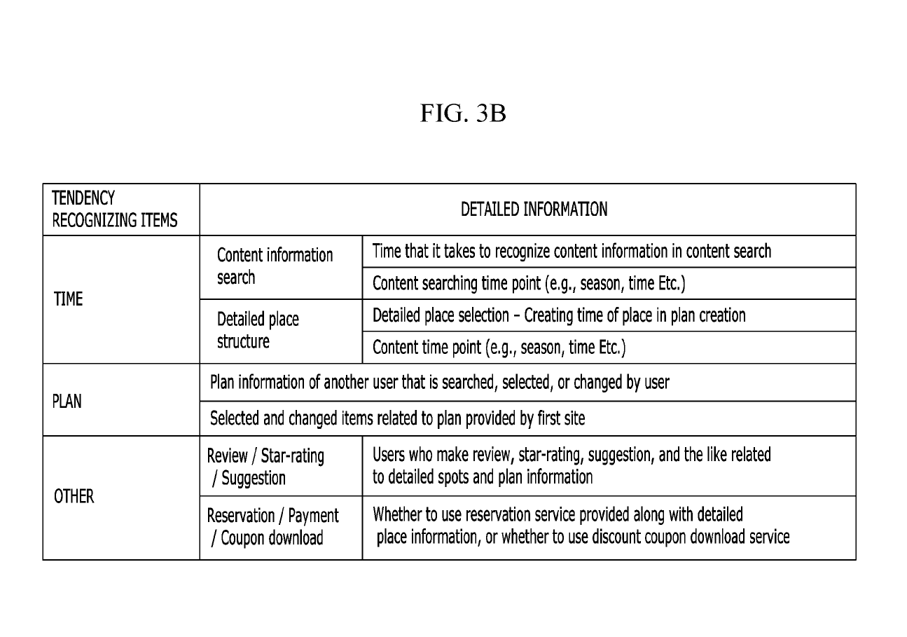

The user tendency database 100 stores tendency information of a user. The user tendency database 100 will be described in detail with reference to FIG. 3A to FIG. 5.

The processor 300 automatically creates the user tendency database 100 and the content database 200. That is, the processor 300 may analyze tendencies of users based on Internet using information of the users. Specially, the processor 300 may determine the tendencies of the users by analyzing content information searched by the users, time information at which the users searched specific contents, patterns (e.g., places are first searched, or schedules are first searched and places are then searched) of the users who use tour plan services, and/or the like. For example, the professor 300 may determine the tendencies of the users by analyzing use patterns and use logs of the users who use Internet sides (hereinafter, referred to as ‘first sites’) for providing tour plan services in accordance with the exemplary embodiment of the present invention. Further, the processor 300 may determine the tendencies of the users by analyzing Internet using histories (e.g., opened page lists, cookies, and search histories) of the users. Specifically, the processor 300 may determine the tendencies of the users by additionally analyzing another Internet using information (related to, e.g., search, visit, writing, and the like) of the users who use other Internet sites than the first sites.

Further, the processor 300 may determine the tendencies of the users by analyzing SNS (social network service) using history (e.g., all information that is obtained through agreements of the users by using open API, such as pages clicked with the ‘like button’ in the Facebook or the like, posted writings, reviews, and the like) of the users. The processor 300 may generate data that can be used for marketing or promotion purpose by collecting tour reviews made by the users.

In the meantime, the processor 300 may flexibly change attributes of the place contents on the basis of the tendencies of the users. Specifically, the processor 300 may change a secondary attribute of a specific place content according to tendencies of at least one user who uses the specific place content. For example, when a first place content of which primary attribute is culture is used by a plurality of users having a shopping tendency (i.e., a tendency preferring an area at which the users can do their shopping), the processor 300 may change the secondary attribute of the first place content into a shopping attribute. As a result, the place content may have the primary attribute of culture and the secondary attribute of shopping.

The processor 300 may provide a tour plan optimized for a current tendency of a user thereto by matching the user tendency database 100 to the content database 200. Herein, a user terminal may be a device including a display apparatus such as a personal computer, a laptop computer, and a smart phone.

FIG. 2 conceptually shoes attributes of place contents in accordance with the exemplary embodiment of the present invention.

Each place content may have one primary attribute 10 and at least one secondary attribute 21-26. A ratio between the primary attribute 10 and the secondary attribute 21-26 may be 51:49. In other words, the primary attribute 10 of a place content is a constant value that is predetermined, and the secondary attributes 21-26 may be flexibly changed according to a tendency ratio of a user who uses (or searches) the place content. For example, when the number of users who have a first tendency among users using a specific place content is greater than that of users who have another tendency, the place content may have an attribute corresponding to the first tendency as one of the secondary attributes

For easy of description, FIG. 2 illustrates the case that a specific content has the primary attribute 10, the secondary attribute 22, the secondary attribute 24, and the secondary attribute 21 and 23 in that order. For example, when 100 users having a history attribute (i.e., an attribute preferring historic spot), 80 users having a tourism attribute (i.e., an attribute preferring a tourist spot), 30 users having a culture attribute (an attribute preferring a cultural area), and 30 users having a nature attribute (i.e., an attribute preferring a natural area) uses (or searches) a second place content having the primary attribute 10 of shopping, the second place content may have the primary attribute 10 of shopping and the secondary attribute 22 of history.

The tour service providing apparatus 1000 provides (or suggests) a tour plan that is appropriate for a user tendency by matching the user tendency to various attributes of the place content. Further, the processor 300 may analyze a preferential tendency of a user related to a specific place by further using reservation information of the user, a purchase list of the user, suggestion information of the user, rating information (e.g., satisfaction information) of the user related to the place content, and/or the like.

In the meantime, such place contents may be categorized as follows.

TABLE 1

| | | Detailed |
|---|---|---|
| | | information for |
| First: Category | Second: Type | registering places |
| ALL | ALL | Name (Necessary) |
| Tourist spots | ALL | Category/type field |
| (Must see) | | (Necessary) |
| Shopping | Road shop/Mall/Market/ | Address (Necessary) |
| | Department store/Outlet/etc. | Details (Necessary) |
| Culture | Art gallery/Museum/Movie/ | Place picture |
| | Concert/Exhibit/Entertainment/ | Telephone |
| | etc. | Available time/ |
| | | Holidays |
| History | Architecture (E.g., Temple, | Price information |
| | Catholic church)/Ruin/Folk | Homepages |
| | village/etc. | Checking whether to |
| Nature | Park/Mountain/Bitch/Lake/River/ | share information |
| | etc. | related to |
| | | registered place |
| Experience | Festival/Ceremony/Theme park/ | (Publication default) |
| | Camping/etc. | |
| Restaurant | Food/Cafe/etc. | |
| Accom- | Hotel/Motel/(Bed&Breakfast)/etc. | |
| modation | | |
| Traffic | Air plane/Train/Bus/Subway/etc. | |

The category in Table 1 corresponds to the attribute of the aforementioned place content. Each category may include at least one detailed type. The place contents are first categorized per category, and are second categorized per type.

In the meantime, each place content may have a flexible time attribute. The time attribute of each place content is basically set one hour, but may be changed by users. Specifically, when a user directly registers a place content, the user may set a time attribute value of the place content (hereinafter, referred to as ‘a first time value’). Further, the time attribute value of the place content may be changed according to an average time applied by users for the place contents in tour plans (hereinafter, referred to as ‘a second time value’). For example, the time attribute of the place content may be changed into an average value of the first time value and the second time value.

In the meantime, the tour service providing apparatus 1000 may select a place content by matching a user tendency to an attribute of the place content, and adjust the number of place contents included in a tour plan according to a time attribute of the selected place content. For example, the tour service providing apparatus 1000 may use a time applied for a specific place content included in a tour plan or a time attribute value of the place content inputted in the registration of place content by a user whose tendency is recognized, so as to determine an average time value which users of the tendency apply to the place content. When a tour plan including a place content having the same attribute as that of the place content (hereinafter, referred to as ‘a same attribute place content’) is provided, the tour service providing apparatus 1000 may assign the determined average time value for the same attribute place content).

FIG. 3A and FIG. 3B show information that is collected to recognize user tendencies in accordance with the exemplary embodiment of the present invention.

Items for recognizing user tendencies may be categorized into Internet using information of a user, user information, search information for travel destinations, contents searching information, time information, plan searching information, and other information.

The Internet using information includes first information searched by a user to be related to travels, cities, or detailed spots in a city (hereinafter, referred to as ‘a sub place’) in addition to a first site. The tour service providing apparatus 1000 determines travel destinations in which a user is interested and their sub places by collecting and analyzing the first information. Specifically, the tour service providing apparatus 1000 collects the first information to recognize a basic user tendency before creating the user tendency database 100. Then, the tour service providing apparatus 1000 generates data related to interesting travel destination information and interesting sub places by analyzing first collected information and information related to cities in the first cite searched by the user and the sub places

The user information includes an Internet accessing position of the user, sex, and age. The tour service providing apparatus 1000 determines which travel destination is most popular with which user from which area through personal information and position information obtained from a user when the user signed up for membership.

The search information for travel destinations includes travel destination information such as nations or cities that the user mainly searches in the first site. The tour service providing apparatus 1000 collects the travel destination information to recognize in which area the user is currently interested.

The contents searching information includes information that the user searches and selects for the categories and types of the place contents in the first site. The tour service providing apparatus 1000 collects the contents searching information to recognize objects, interested fields, and preferential tendencies of currently planned travel of the user. The tour service providing apparatus 1000 may determine the sub places of a suggested tour plan on the basis of the contents searching information. Further, the tour service providing apparatus 1000 may determine which sub places the user prefers by analyzing which categories and types are mostly searched and selected by the user. In addition, the tour service providing apparatus 1000 may recognize an attribute of the place that is currently searched by the user, and match the recognized attribute to the user tendency recognized through existing use information of the user to deduce a specific place. The tour service providing apparatus 1000 may add the deduced place into the tour plan. For example, when a user is determined to be a shopper by mainly doing the shopping and is currently searching vacation spots, the tour service providing apparatus 1000 makes a tour plan that satisfies both shopping and resting.

The time information may include a time that it takes for the user to search and recognize specific content information, and a time point (e.g., season, time, or the like) at which the user performs the search. The tour service providing apparatus 1000 recognizes an interest level in a content on the basis of a time that it takes for a user to search and recognize information related to the content. The tour service providing apparatus 1000 in what season or at what time the user manly searches the content information (e.g., users mainly search Jongro at night at the end of the year) by using the time point at which the user searches the content. In the meantime, the time information may include a time occupied by the place content selected by the user, and a time point (e.g., season, time, or the like) of the content. The tour service providing apparatus 1000 recognizes how much time the user applies for the selected place in the tour plan (e.g., preferential user tendency and using time) by using information related to the time occupied by the place content selected by the user in the tour plan. Further, the tour service providing apparatus 1000 recognizes in which season the user selects the place content and at which time zone the user adds the place content into the tour plan by using the time point of the content.

The plan searching information may include tour plan information of another user that is searched, selected, or changed by the user, and selection and change information related to the tour plan provided from the first site. The tour service providing apparatus 1000 recognizes what tour plan is selected by a user having what tendency or how the user changes the tour plan by using the plan searching information, to recognize a user tendency, a tour plan, place information included in the tour plan.

Other information may include user review information, star rating information, and suggestion information. The tour service providing apparatus 1000 may determine what opinion on the provided information is offered by a user having what tendency by recognizing the users who offer reviews, star ratings, suggestion, and the like for the tour plan and the place. Such determined information may be used for promotion. Further, the other information may include reservation information, payment information, and coupon download information. The tour service providing apparatus 1000 may recognize the user who confirms use of the place (i.e., the user who makes place reservation, use payment, or discount coupon download) by using use information of the user related to a reservation service and a discount coupon download service provided along with place information, and apply a preferential weight of the place to the user who confirms the use of the place. This is because the reservation, the payment, the coupon download information and/or the like may be used as a real use basis of the user related to the place rather than simple search.

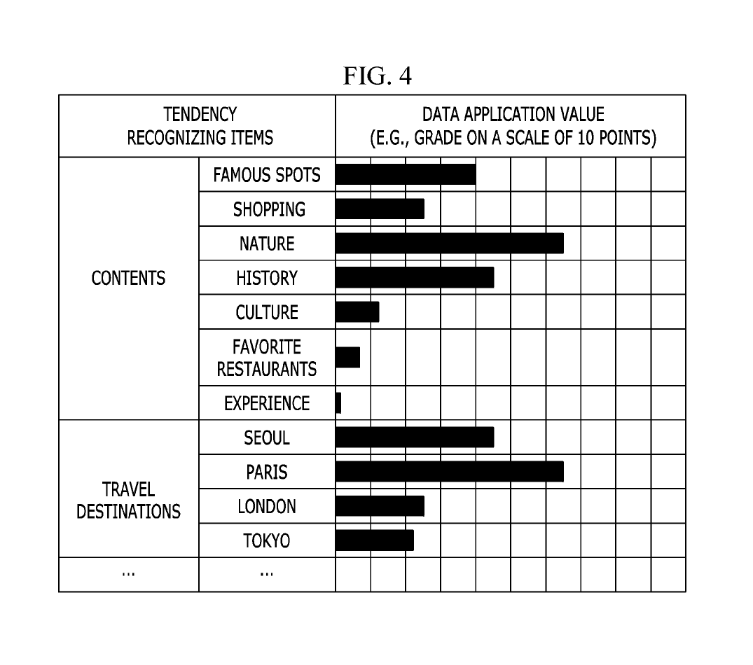

FIG. 4 shows one example of user tendency information in accordance with the exemplary embodiment of the present invention.

An item for recognizing a user tendency may be divided into a place content, a travel destination, and/or the like described in FIG. 3A and FIG. 3B. The user tendency information may include a value obtained by digitizing a level of the user tendency for the place content, the travel destination, and/or the like. For example, the user tendency information may include a tendency value (or a preference level) of a user for each attribute (or category) of the place content. Further, the user tendency information may include a tendency value (or a preference level) of a user for each travel destination (e.g., Seoul, Paris, London, Tokyo, and the like). The tour service providing apparatus 1000 creates the user tendency database 100 by automatically making the user tendency as data based on such user tendency information.

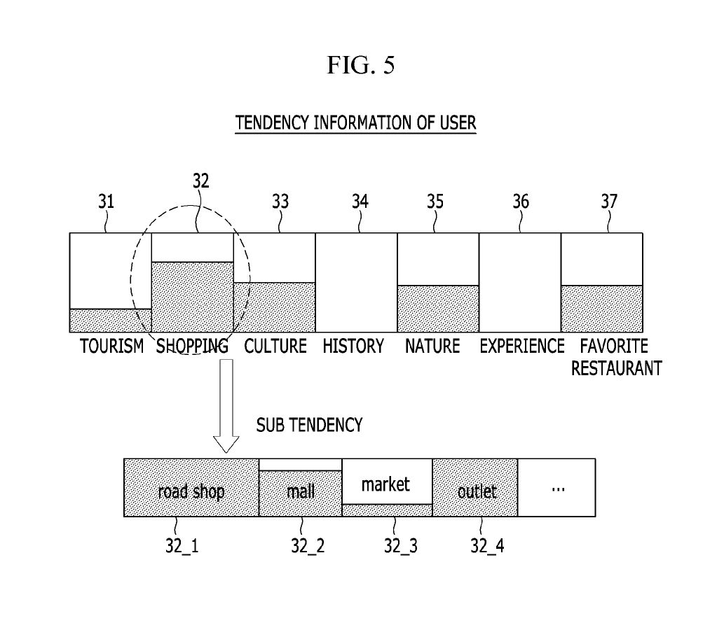

FIG. 5 shows another example of user tendency information in accordance with the exemplary embodiment of the present invention.

FIG. 5 illustrates a case that tendency information of a specific user stored in the user tendency database 100 includes a shopping tendency 32, a culture tendency 33, a nature tendency 35, a favorite restaurant tendency (i.e., a tendency preferring a region at which a preferential restaurant is located) 37, a tourism tendency 31, a history tendency 34, and an experience tendency (i.e., a tendency preferring a region at which a user can perform an experience activity) 36 in that order. Each tendency information 31˜37 may include at least one sub tendency. Herein, the sub tendencies correspond to the types shown in Table 1. FIG. 5 illustrates a case that the shopping tendency 32 includes a load shop 32_1, an outlet 32_4, a moll 32_2, and a market 32_3 in that order. In the meantime, the user tendency information stored in the user tendency database 100 may be flexibly changed according to Internet using information of the user during a time period (e.g., a pattern by which the user uses the first site)

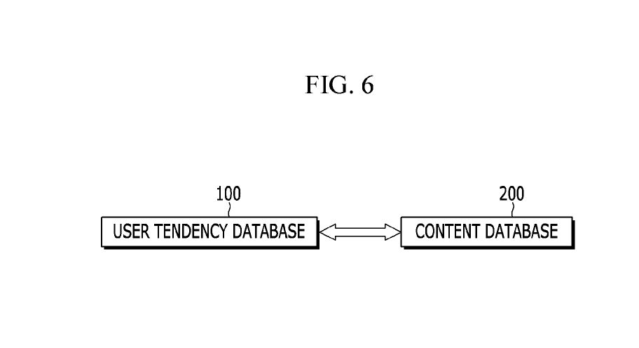

FIG. 6 is a graph showing a relationship between user tendencies and place contents in accordance with the exemplary embodiment of the present invention.

As described above, the attribute of the place content stored in the content database 200 may be changed according to the user tendency information stored in the user tendency database 100. For example, when a plurality of users who have the culture tendency use a third place content having the primary attribute of history relatively many times, the secondary attribute of the third place content may be changed into the culture attribute.

Further, the tour service providing apparatus 1000 at least one place content corresponding to the user tendency information among the place contents stored in the content database 200, and creates a tour plan by using the selected place content to provide it to the user.

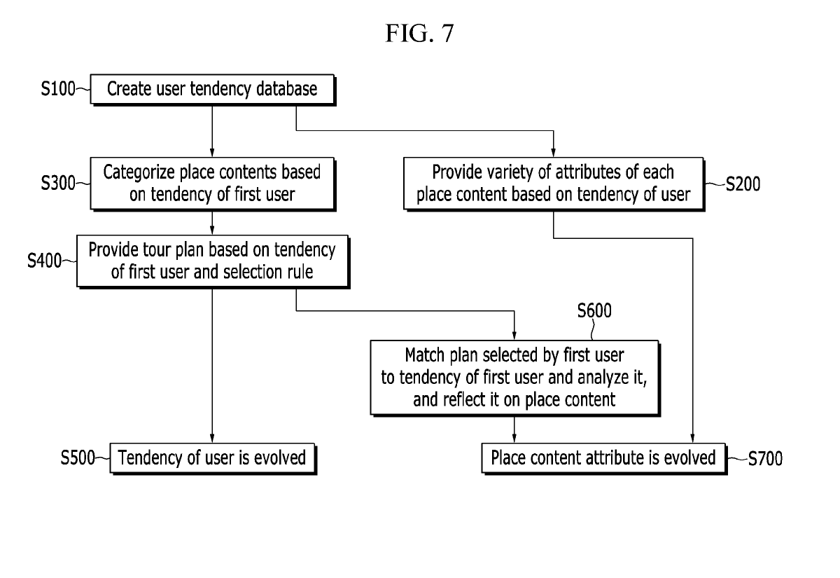

FIG. 7 is a flowchart showing how the tour service providing apparatus provides a tour plan service in accordance with the exemplary embodiment of the present invention.

The tour service providing apparatus 1000 creates the user tendency database 100 (S100). Specifically, the tour service providing apparatus 1000 analyzes a tendency of a first user based on Internet using information (e.g., using history of the first site) of the first user, and stores the analyzed tendency information in the user tendency database 100.

The tour service providing apparatus 1000 creates the content database 200. Specifically, the tour service providing apparatus 1000 gives a variety of attributes of each place content based on the tendencies of the users (S200). For example, the tour service providing apparatus 1000 changes the attribute of each place content according to a tendency ratio of the users who use the corresponding place content. Accordingly, the attributes of the place contents are continuously evolved (S700).

In the meantime, the tour service providing apparatus 1000 categories the place contents based on the tendency information of the first user stored in the user tendency database 100 (S300). Specifically, the tour service providing apparatus 1000 searches at least one fourth place content corresponds to tendency information of the first user among the place contents stored in the content database 200.

The tour service providing apparatus 1000 creates a tour plan based on the tendency of the first user and a selection rule inputted from the first user, or based on the tendency of the first user without receiving the selection rule to provide it to the first user (S400). Here, the selection rule may be at least one of a tour schedule (or a tour date), a travel destination, a place content attribute (or a preferential place category), and a travel expense.

In the case that no selection rule is inputted, the tour service providing apparatus 1000 may determine at least one travel destination (e.g., a city such as Paris or London), a tour schedule, and at least one detailed tourist spot (e.g., special spots such as a museum, an art gallery, and a park in the travel destination), which are popular (preferred by the users) in the current season (or quarter) by using the fourth place contents. For example, the tour service providing apparatus 1000 may determine at least one travel destination, a tour schedule, and at least one detailed tourist spot, which are preferred (or used at a number of times that is equal to or greater than a first threshold value) by users having the same (or similar) tendencies as the first user (hereinafter, referred to as ‘second users’) in the current season by using the fourth place contents. Further, the tour service providing apparatus 1000 may create and provide a tour plan including the determined tour schedule, travel destination, and detailed tourist spot. In addition, the tour service providing apparatus 1000 may provide tour plans having the number of times at which they are suggested by users that is equal to or greater than a second threshold value among the tour plans including the fourth place content. For example, the tour service providing apparatus 1000 may provide tour plans having the number of times at which they are suggested by the second users that is equal to or greater than a second threshold value among the tour plans including the fourth place contents. Further, the tour service providing apparatus 1000 may provide a tour plan that is created by a travel editor (or a travel expert) by using the fourth place contents.

Further, the tour service providing apparatus 1000 may provide at least one tour plan (e.g., three tour plans) that satisfies the inputted selection rule to the user. For example, when the inputted selection rule is the tour schedule, the tour service providing apparatus 1000 categorizes the fourth place contents based on the inputted schedule (that may include a tour date, a time-unit schedule, or the like). Specifically, the tour service providing apparatus 1000 may search at least one fifth place content corresponding to the inputted tour schedule among the fourth place contents. In addition, the tour service providing apparatus 1000 may determine at least one travel destination (e.g., cities such as Paris, London, and the like) by using the fifth place content, and create and provide a tour plan including the determined travel destination. Specifically, the tour service providing apparatus 1000 may determine at least one destination (e.g., cities such as Paris, London, and the like) and at least one detailed tourist spots (e.g., a museum, an art gallery, and a park in the travel destination) by using the fifth place content, and create and provide a tour plan including the detailed tourist spots. Moreover, the tour service providing apparatus 1000 may provide a tour plan that is used (or selected) many times by the second users among the tour plan including the fifth place content. Specifically, the tour service providing apparatus 1000 may provide a tour plan that is used by the second users at a number of times that is equal to or greater than a third threshold value among the tour plans including the fifth place content. Further, the tour service providing apparatus 1000 may provide a tour plan that is created by a travel editor (or a travel expert) by using the fifth place content.

In the meantime, when the inputted selection rule is the travel destination, the tour service providing apparatus 1000 categories the fourth place contents based on at least one inputted travel destination. Specifically, the tour service providing apparatus 1000 may search at least one sixth place content corresponding to the inputted travel destination among the fourth place contents. Further, the tour service providing apparatus 1000 may determine a tour schedule and at least one detailed tourist spots (e.g., a museum, an art gallery, and a park in the travel destination) by using the sixth place content, and create and provide a tour plan including the determined tour schedule and detailed tourist spots. Moreover, the tour service providing apparatus 1000 may provide a tour plan that is used (or selected) many times by the second users among the tour plan including the sixth place content. Specifically, the tour service providing apparatus 1000 may provide a tour plan that is used by the second users at a number of times that is equal to or greater than a fourth threshold value among the tour plans including the sixth place content. Further, the tour service providing apparatus 1000 may provide a tour plan that is created by a travel editor (or a travel expert) by using the sixth place content.

In the meantime, when the inputted selection rule is the place content attribute (or the preferential place category), the tour service providing apparatus 1000 categories the fourth place contents based on at least one inputted attribute (or category). Specifically, the tour service providing apparatus 1000 may search at least one seventh place content corresponding to the inputted attribute among the fourth place contents. Further. The tour service providing apparatus 1000 may determine a tour schedule and at least one travel destination by using the seventh place content, and provide a tour plan including the determined tour schedule and travel destination. Moreover, the tour service providing apparatus 1000 may provide a tour plan that is used (or selected) many times by the second users among the tour plan including the seventh place content. Specifically, the tour service providing apparatus 1000 may provide a tour plan that is used by the second users at a number of times that is equal to or greater than a fifth threshold value among the tour plans including the seventh place content. Further, the tour service providing apparatus 1000 may provide a tour plan that is created by a travel editor (or a travel expert) by using the seventh place content.

In the meantime, when the inputted selection rule is the travel expense, the tour service providing apparatus 1000 categories the fourth place contents based on at least one inputted travel expense. Specifically, the tour service providing apparatus 1000 may search at least one eighth place content corresponding to the inputted attribute among the fourth place contents. Further. The tour service providing apparatus 1000 may determine a tour schedule, at least one travel destination, and at least one detailed tourist spot by using the eighth place content, and provide a tour plan including the determined tour schedule, travel destination, and detailed tourist spot. Moreover, the tour service providing apparatus 1000 may provide a tour plan that is used (or selected) many times by the second users among the tour plan including the eighth place content. Specifically, the tour service providing apparatus 1000 may select tour plans that are used by the second users among the tour plans including the eighth place content, and may provide a tour plan corresponding to the travel expense among the selected tour plans

At a number of times that is equal to or greater than a sixth threshold value. Further, the tour service providing apparatus 1000 may provide a tour plan that is created by a travel editor (or a travel expert) by using the seventh place content.

In the meantime, when a plurality of selection rules are inputted, the tour service providing apparatus 1000 categories the fourth place contents based on a combination of inputted values corresponding to the selection rules. For example, when two selection rules (e.g., the tour schedule and the travel destination) are inputted, the tour service providing apparatus 1000 may search at least one ninth place content corresponding to the combination of inputted values corresponding to the selection rules among the fourth contents. The tour service providing apparatus 1000 determine an item that is not inputted by the user among a tour schedule, at least one travel destination, and at least one detailed tourist spot, and creates and provides a tour plan including the determined item. Moreover, the tour service providing apparatus 1000 may provide a tour plan that is used (or selected) many times by the second users among the tour plan including the ninth place content. Further, the tour service providing apparatus 1000 may provide a tour plan that is created by a travel editor by using the ninth place content.

The first user may select at least one of the tour plans provided by the tour service providing apparatus 1000 in step S400. Further, the tour service providing apparatus 1000 may match the tour plan selected by the first user to the tendency of the first user and analyze it to reflect the analyzed result on the attribute of the place content included in the selected tour plan (S600). Through step S600, the attribute of the place content may be continuously evolved (S700). In the meantime, the tour service providing apparatus 1000 may analyze the tour plan selected by the first user to reflect the analyzed result on the tendency of the first user. Moreover, the tour service providing apparatus 1000 may continuously analyze internet using information of the first user to reflect the analyzed result on the tendency of the first user. Accordingly, the tendency of the first user may be continuously evolved (S500).

In the meantime, when a member database (not shown) and a plan database (not shown) are created, the tour service providing apparatus 1000 may additionally provide a tour plan that is suggested by a power user per place category (or attribute of the place content). Here, the power user indicates a provider of information that is searched, referred to, and shared by users.

In accordance with the exemplary embodiments of the present invention, it is possible to create the user tendency database by automatically recognizing (analyzing) a tendency of a user who searches travel destination information and a planner service.

In accordance with the exemplary embodiments of the present invention, it is also possible to automatically provide a tour plan optimized for the user based on the created user tendency database in a form of contents.

In accordance with the exemplary embodiments of the present invention, it is also possible to provide contents (e.g., suggested tour course) of a tour plan service optimized for the tendency of the user instead of a general tour course.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a tour plan service by a tour service providing apparatus, the method comprising:
determining a tendency of a first user based on Internet using information of the first user;
searching at least one first place content corresponding to the tendency of the first user; and
providing a first tour plan created by using the first place content, to the first user.

2. The method of claim 1, wherein the demining of the tendency of the first user includes creating a first database for storing tendency information of the first user based on the Internet using information of the first user, and
the Internet using information of the first user includes at least one of information related to use of the tour plan service by the first user, information related to use of a service different from the tour plan service by the first user, and information related to use of a social network service (SNS) by the first user.

3. The method of claim 2, wherein the first place content includes at least one attribute, and
the searching includes searching the first place content having an attribute corresponding to the tendency of the first user by using a second database for storing at least one place content.

4. The method of claim 3, wherein the attribute of the first place content is adjusted based on a tendency of a user who uses the first place content.

5. The method of claim 4, wherein the first place content includes:
a primary attribute having a predetermined value; and
a secondary attribute that is adjusted based on the tendency of the user who uses the first place content.

6. The method of claim 5, wherein the providing includes:
receiving a selection rule from the first user; and
creating the first tour plan based on the selection rule.

7. The method of claim 6, wherein the selection rule is at least one of a tour schedule, a travel destination, a place content attribute, and a travel expense.

8. The method of claim 7, wherein the creating of the first tour plan includes, when no selection rule is inputted,
determining at least one travel destination, a tour schedule, and a sub tour place in the travel destination, which are preferred by users having the same tendencies as the first user in a current season by using the first place content;
creating a first tour plan including the determined travel destination, tour schedule, and sub tour place; and
selecting a second tour plan having a number of times at which they are suggested that is equal to or greater than a threshold value among tour plans including the first place content.

9. The method of claim 7, wherein the creating of the first tour plan includes, when the travel destination is inputted as the selection rule,
searching at least one second place content corresponding to the inputted travel destination among the first place contents;
determining a tour schedule and at least one sub tour place in the travel destination by using the second place content, and creating a first tour plan including the determined tour schedule and sub tour place; and
selecting a second tour plan that is used by users having the same tendencies as the first user among tour plans including the second place content.

10. The method of claim 7, wherein the creating of the first tour plan includes, when the place content attribute is inputted as the selection rule,
searching at least one second place content corresponding to the inputted attribute among the first place contents;
determining a tour schedule and at least one travel destination by using the second place content, and creating a first tour plan including the determined tour schedule and travel destination; and
selecting a second tour plan that is used by users having the same tendencies as the first user among tour plans including the second place content.

11. The method of claim 7, wherein the creating of the first tour plan includes, when the travel expense is inputted as the selection rule,
searching at least one second place content corresponding to the inputted travel expense among the first place contents;
determining a tour schedule, at least one travel destination, and at least one sub tour place in the travel destination by using the second place content, and creating a first tour plan including the determined tour schedule, travel destination and sub tour place; and
searching tour plans that are used by users having the same tendencies as the first user among tour plans including the second content, and selecting a second tour plan corresponding to the inputted travel expense among the searched tour plans.

12. The method of claim 7, wherein the creating of the first tour plan includes, when the tour schedule is inputted as the selection rule,
searching at least one second place content corresponding to the inputted tour schedule among the first place contents;
determining at least one travel destination by using the second place content, and creating a first tour plan including the determined travel destination; and
selecting a second tour plan that is used by users having the same tendencies as the first user among tour plans including the second place content.

13. A tour service providing apparatus for providing a tour plan service, the apparatus comprising:
a first database configured to store user tendency information of at least one user;
a second database configured to store at least one place content; and
a processor configured to create a tour plan by matching the tendency information of the users to the place contents,
wherein the processor stores, in the first database, tendency information of a first user among the users, analyzed based on Internet using information of the first user,
searches at least one first place content corresponding to the tendency information of the first user among the place contents by using the second database, and
provides a first tour plan created by using the first place content, to the first user.

14. The apparatus of claim 13, wherein the attribute of the first place content is adjusted based on a tendency of a second user who uses the first place content among the users.

15. The apparatus of claim 14, wherein the processor creates the first tour plan based on a selection rule inputted from the first user, and
wherein the selection rule is at least one of a tour schedule, a travel destination, a place content attribute, and a travel expense.
